(19) United States
(12) Patent Application Publication
(10) Pub. No.: US 2026/0275565 A1
(43) Pub. Date: Sep. 17, 2026

(54) COUNTER ELECTRODES FOR REVERSIBLE METAL ELECTRODEPOSITION

(71) Applicant: Tynt Technologies, Inc., Boulder, CO (US)

(72) Inventors: Claudio Marchi, Broomfield, CO (US); Tyler James Quill, Denver, CO (US); Tyler Steven Hernandez, Boulder, CO (US)

(73) Assignee: Tynt Technologies, Inc., Boulder, CO (US)

(21) Appl. No.: 19/532,473

(22) Filed: Feb. 6, 2026

Related U.S. Application Data
(60) Provisional application No. 63/764,155, filed on Feb. 27, 2025.

(51) Int. Cl. C25D 17/10; H01M 4/04

(52) U.S. Cl. CPC C25D 17/10; H01M 4/0402

(57) ABSTRACT

The present disclosure provides improved counter electrodes for reversible metal electrodeposition-based devices and methods for their manufacture. The counter electrodes feature a multi-layer architecture comprising a conductive core, a functional interlayer, and an active outer shell. The functional interlayer provides both chemical protection and mechanical stability while maintaining optical transparency. Various manufacturing methods are disclosed, including vapor deposition, electroplating, and additive manufacturing, suitable for both batch and continuous production. The improved design enables enhanced durability and performance in applications such as dynamic glass while maintaining visible light transmission above 50%. Manufacturing methods are optimized for precise control of layer properties and interfaces, enabling reliable production at commercial scale.

### CROSS-REFERENCE TO RELATED APPLICATIONS

This application claims priority to U.S. Provisional Patent Application No. 63/764,155, filed Feb. 27, 2025, the content of which is incorporated herein by reference in its entirety.

### FIELD

The present disclosure relates generally to counter electrodes for use in reversible metal electrodeposition-based devices and methods for manufacturing such counter electrodes.

### BACKGROUND

Dynamic glass, also known as smart glass or switchable glass, are gaining increasing attention in architectural and automotive applications for their ability to actively control light transmission. Among various dynamic glass technologies, reversible metal electrodeposition (RME) has emerged as a promising approach due to its rapid switching speeds, high contrast ratios, and potential for low manufacturing costs.

RME-based devices operate through the controlled deposition (plating) and stripping of metals on electrodes. A critical component in these devices is the counter electrode, which must maintain both electrical conductivity and optical transparency while withstanding the repeated cycles of plating and stripping during RME. Traditional processes focus on the synthesis and deposition of a single metallic layer on free-standing woven counter electrodes, and the material selection and electrode fabrication of which have been limited to metals directly involved in the RME reactions. However, these conventional designs often suffer from degradation through chemical corrosion and mechanical failure, leading to shortened device lifetimes.

Current challenges in RME counter electrode technology include maintaining long-term stability against chemical degradation, ensuring mechanical integrity during cycling, and preserving optical transparency. The chemical interaction between the electrode materials and the electrolyte can lead to unwanted ion leaching, while mechanical stress during cycling can cause structural failures such as cracking and delamination. Additionally, achieving high optical transparency while maintaining sufficient electrical conductivity presents a significant materials engineering challenge.

Therefore, there exists a need for improved counter electrode designs and manufacturing methods that can deliver enhanced durability and performance while maintaining the required optical and electrical properties for RME-based devices, and that can be manufactured efficiently at commercial scale.

### BRIEF SUMMARY

Accordingly, the present disclosure addresses this need by providing improved counter electrodes for reversible metal electrodeposition (RME) devices and methods for their manufacture that overcome the limitations of conventional designs. The counter electrodes described herein feature a multi-layer architecture, comprising a conductive core, a functional interlayer, and an active outer shell. This architecture enables significantly enhanced chemical stability and mechanical durability while maintaining the optical and electrical properties required for applications such as dynamic glass.

The conductive core provides the primary electrical conductivity, with a bulk conductivity greater than 1×10⁶ Siemens per meter (S/m). The functional interlayer serves a dual purpose of protecting the core from chemical/electrochemical interactions with the electrolyte and providing mechanical stability during cycling. The active outer shell contains metals that participate in the RME process. The entire structure maintains a visible light transmission (VLT) greater than 50% at λ=550 nm, rendering effective transparency. As such, the disclosed structure is suitable for applications such as dynamic glass.

Various manufacturing methods are disclosed for producing such counter electrodes efficiently and reliably. These methods include physical vapor deposition, chemical vapor deposition, electroplating, electroless plating, chemical coating, and additive manufacturing. These fabrication methods can be implemented in both batch and continuous production processes, offering flexibility in manufacturing scale and approach. The methods enable precise control over layer properties and interfaces, which is critical for achieving the desired performance characteristics.

The disclosed counter electrodes and RME devices incorporating such counter electrodes can be used in a variety of applications across different industries. For example, they can be used in dynamic windows (also known as smart windows) in architecture, which improve energy efficiency by regulating solar heat gain while maintaining aesthetics. In transportation, these electrodes enable dynamic windows in aircraft, automobiles, and marine vessels that enhance passenger comfort by controlling light and temperature without mechanical shades. For wearable applications, the technology supports dynamic eyewear that adapts to changing light conditions for both everyday use and specialized needs in sports and medical therapy. Additional implementations include privacy solutions in healthcare settings, interactive retail displays, and components for advanced display technologies.

### BRIEF DESCRIPTION OF THE DRAWINGS

FIG. 1 illustrates schematic cross-sections of exemplary RME counter electrode architectures in both radial (left) and planar (right) configurations.

FIGS. 2A and 2B collectively show exemplary microscope images comparing the impact of material selection and optimized fabrication on counter electrode quality, demonstrating the effect of proper functional layer implementation. FIG. 2A shows a counter electrode with a poorly shielding functional layer leading to nickel leaching in the electrolyte (green color). FIG. 2B shows the same electrolyte used in a device with a properly selected and fabricated functional layer.

FIGS. 3A and 3B collectively show exemplary microscope images showing the impact of optimal mechanical properties and fabrication on the mechanical stability of a mesh-like counter electrode. FIG. 3A shows the outer shell flaking from the gold functional interlayer, and FIG. 3B shows a stable and adherent active outer shell maintaining its structural integrity during cycling.

FIG. 4 depicts an exemplary process flow diagram for fabricating counter electrodes using physical and/or chemical vapor deposition processes. This figure illustrates the counter electrode in a series of parallel metal lines, but the pattern needs not be parallel or rectilinear. It is noted that the core(s), interlayer(s), and active layer(s) may be separately deposited through a subsequent series of the above steps, or they could be deposited in a serial fashion through different metallization steps which are then patterned to the desired geometry.

FIGS. 5A and 5B collectively show examples of production lines for chemically or electrolytically coated counter electrodes, showing both batch and continuous processing approaches. FIG. 5A shows an exemplary process flow for a semi-automated batch line. FIG. 5B exemplifies the structure of a potential roll-to-roll process for continuous counter electrode fabrication.

FIG. 6 shows an example of an exemplary flat-bed Drop-on-Demand printing process for the fabrication of multi-material counter electrodes. The illustrated process steps may be repeated as many times as needed to reach the desired dimensional or mechanical features.

### DETAILED DESCRIPTION

The following description is presented to enable a person of ordinary skill in the art to make and use the various embodiments. Descriptions of specific devices, techniques, and applications are provided only as examples. Various modifications to the examples described herein may be readily apparent to those of ordinary skill in the art, and the general principles defined herein may be applied to other examples and applications without departing from the spirit and scope of the various embodiments. Thus, the various embodiments are not intended to be limited to the examples described herein and shown but are to be accorded the scope consistent with the claims.

The present disclosure describes counter electrodes for reversible metal electrodeposition (RME) devices, their methods of manufacture, and their integration into RME devices. The counter electrode can be fabricated in either radial or planar configurations, both comprising three essential layers: a conductive core, a functional interlayer, and an active outer shell.

### Core Structure and Components

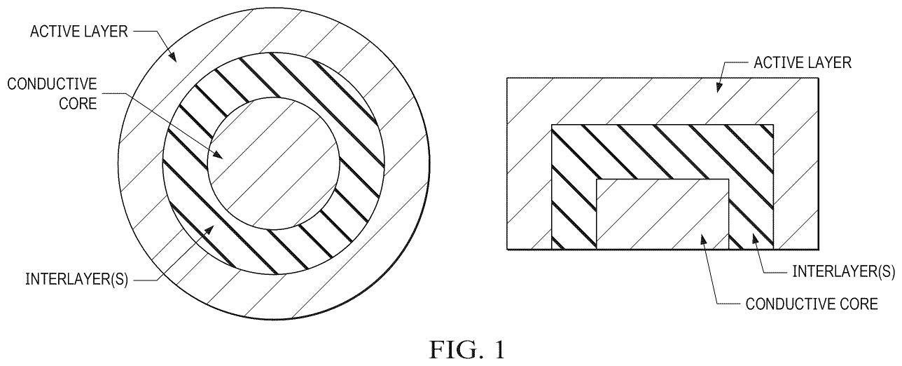

By way of example, FIG. 1 illustrates schematic cross-sections of exemplary RME counter electrode architectures in both radial and planar configurations. Referring to FIG. 1, the counter electrode comprises three primary layers: (1) an inactive core, (2) a functional interlayer, and (3) an active metallic outer shell. The inactive core provides bulk electrical conductivity and may comprise one or more metal layers such as Au, Ag, Cu, Al, W, Ni, Sn, or stainless steel. This core is fabricated to achieve a bulk conductivity value greater than 1×10⁶ Siemens per meter (S/m), where Siemens per meter is the standard SI unit for electrical conductivity measuring how well a material conducts electricity per unit length. The functional interlayer is positioned between the conductive core and active outer shell, providing both chemical protection and mechanical stability. As illustrated in the radial configuration of FIG. 1, this layered structure can be achieved in various geometries while maintaining the essential functional relationships between layers.

The entire structure maintains a visible light transmission (VLT) greater than 50% at λ=550 nm, where λ (lambda) represents the wavelength of light and 550 nanometers corresponds to green light in the middle of the visible spectrum. This wavelength is selected as the standard measurement point as it represents the region where human visual sensitivity is highest and serves as an industry standard reference for transparency measurements.

### Material Selection and Performance

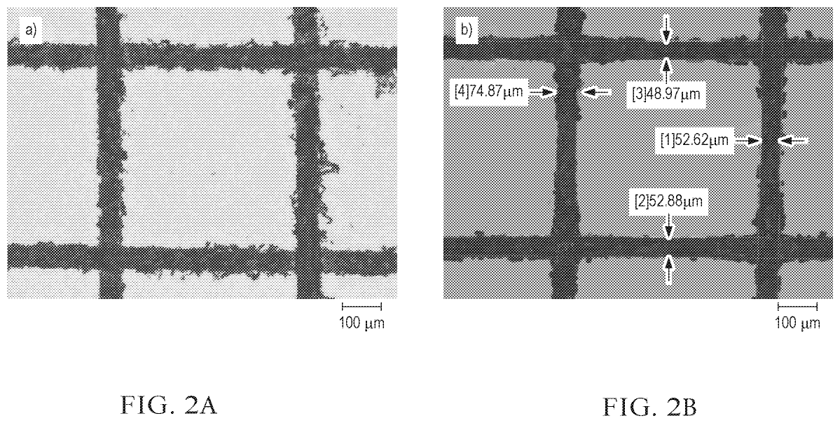

The importance of proper material selection and fabrication is demonstrated in FIGS. 2A and 2B, where FIG. 2A shows the undesirable effects of a poorly designed functional layer, resulting in nickel leaching (indicated by green coloration), while FIG. 2B shows the improved performance achieved with proper material selection and fabrication.

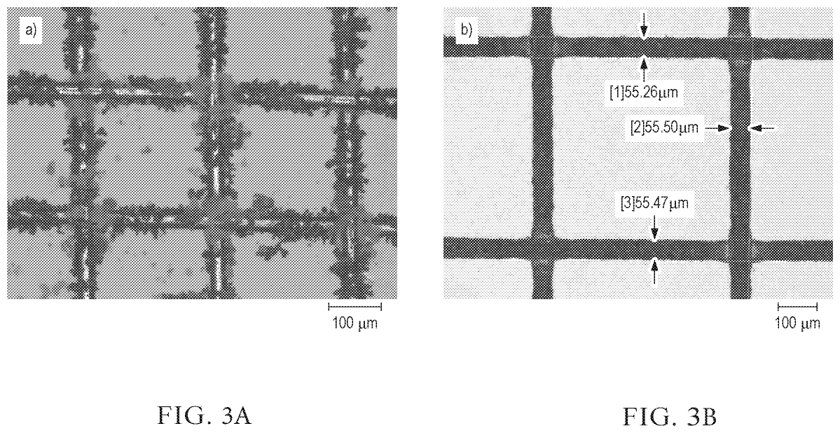

The mechanical stability aspects are illustrated in FIGS. 3A and 3B, where FIG. 3A shows undesirable flaking of the outer shell, and FIG. 3B demonstrates the improved adhesion and structural integrity achieved through optimal material selection and processing conditions.

### Manufacturing Methods and Processes

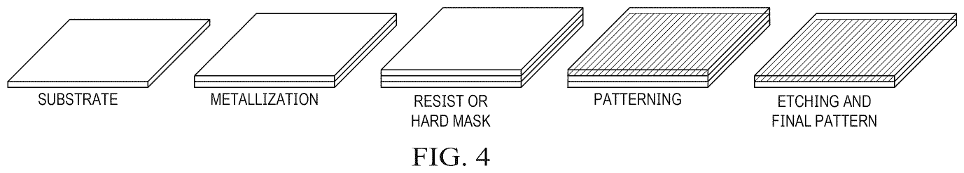

The fabrication of these counter electrodes can be accomplished through several manufacturing approaches, as illustrated in FIGS. 4-6. Each approach offers distinct advantages for different applications and production scales:

Physical/Chemical Vapor Deposition (PVD/CVD): As shown in FIG. 4, the PVD/CVD process involves sequential steps of substrate preparation, metallization, patterning, and etching. This process enables precise control over layer thickness and composition while achieving excellent uniformity. Critical parameters include deposition rate, temperature, and chamber pressure, which must be optimized for each material layer.

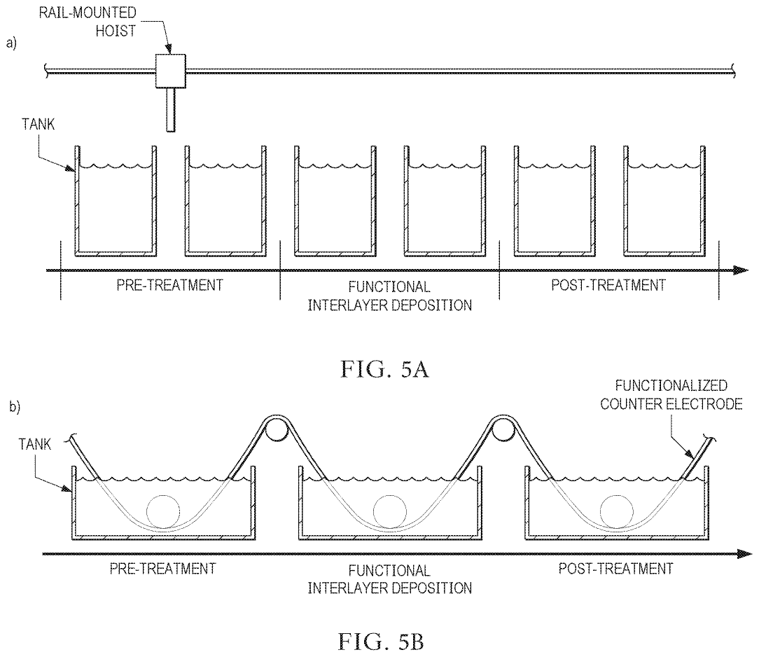

Electroplating/Electroless Plating: FIGS. 5A and 5B collectively illustrate two exemplary production line configurations for wet chemical deposition methods. FIG. 5A shows a semi-automated batch line setup, while FIG. 5B demonstrates a continuous roll-to-roll process. These methods offer cost-effective scaling and are particularly suitable for creating conformal coatings on complex geometries.

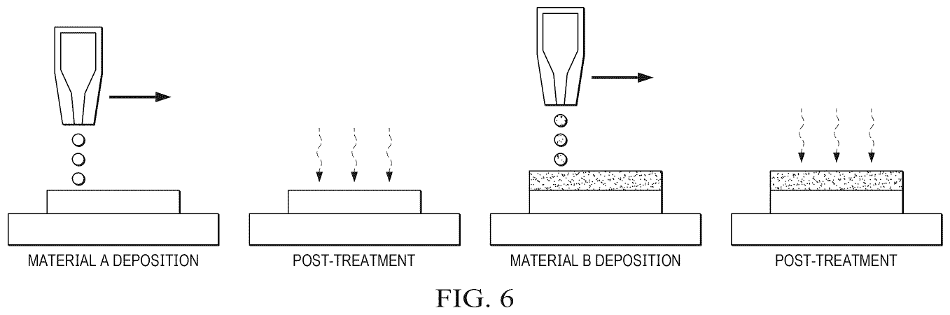

Additive Manufacturing: As illustrated in FIG. 6, layer-by-layer fabrication can be achieved through processes such as Drop-on-Demand printing. This approach allows for customized designs and rapid prototyping of different configurations, with the ability to deposit multiple materials in precise patterns.

While a number of exemplary aspects and embodiments have been discussed above, those of skill in the art may recognize certain modifications, permutations, additions and sub-combinations thereof. It is therefore intended that the following appended claims and claims hereafter introduced are interpreted to include all such modifications, permutations, additions and sub-combinations as are within their true spirit and scope.

### EXAMPLES

The following examples are offered to illustrate provided embodiments and are not intended to limit the scope of the present disclosure.

### Example 1: Enhanced Chemical Stability Through Multi-Layer Design

A counter electrode is fabricated following the architecture shown in FIG. 1 (planar configuration). The electrode comprises a copper core, nickel-phosphorous functional interlayer, and active outer shell. As illustrated in FIG. 2, the implementation of the functional interlayer dramatically improves chemical stability. FIG. 2a shows the result of a poorly shielded copper core, where nickel leaching into the electrolyte is evident by the green coloration. In contrast, FIG. 2b demonstrates the effectiveness of a properly designed functional interlayer, showing no visible evidence of metal ion leaching into the electrolyte during extended cycling tests.

### Example 2: Manufacturing Process Optimization Using PVD/CVD

Following the process flow illustrated in FIG. 4, a series of counter electrodes are fabricated using physical vapor deposition. The substrate is first prepared with standard cleaning procedures, followed by metallization of the conductive core. A critical optimization step involves the patterning process, where the resist or hard mask parameters are adjusted to achieve feature sizes less than 200 micrometers while maintaining pattern fidelity. The final etching step is carefully controlled to prevent undercutting of the metallic layers.

### Example 3: Roll-to-Roll Production Implementation

A continuous manufacturing process is developed based on the configuration shown in FIG. 5b. The process incorporates three main stages: pre-treatment, functional interlayer deposition, and post-treatment. The line speed is optimized at 2 meters per minute, with careful control of tension to prevent substrate deformation. The functional interlayer is deposited using a sulfamate nickel bath, which provides superior ductility compared to traditional bright nickel formulations, as evidenced by mechanical stability testing.

### Example 4: Additive Manufacturing of Complex Patterns

Using the Drop-on-Demand printing process illustrated in FIG. 6, counter electrodes with complex geometric patterns are fabricated. The process demonstrates the ability to deposit multiple materials sequentially while maintaining precise alignment between layers. Material A comprises the conductive core pattern, while Material B is optimized for the functional interlayer properties. Post-treatment steps are critical for ensuring proper adhesion between layers and achieving the desired mechanical properties.

Taken together, these examples demonstrate successful implementation of the multi-layer counter electrode architecture and its manufacturing methods. The functional interlayer effectively prevents ion leaching while providing mechanical stability during cycling, achieving both high optical transparency and electrical conductivity. The demonstrated success across multiple fabrication techniques validates the commercial viability of the invention for dynamic glass applications.

What is claimed is:

1. A counter electrode for a reversible metal electrodeposition device, the counter electrode comprising:
a conductive core;
a functional interlayer disposed on the conductive core; and
an active outer shell disposed on the functional interlayer.

2. The counter electrode of claim 1, wherein the conductive core has a bulk conductivity greater than 1×10⁶ S/m.

3. The counter electrode of claim 1, wherein the functional interlayer comprises at least one material selected to shield the conductive core from chemical and electrochemical interactions with an electrolyte.

4. The counter electrode of claim 1, wherein the active outer shell comprises at least one metal that participates in reversible metal electrodeposition.

5. The counter electrode of claim 1, wherein the counter electrode has a visible light transmission greater than 50% at λ=550 nm.

6. The counter electrode of claim 1, wherein the conductive core comprises one or more metals selected from the group consisting of Au, Ag, Cu, Al, W, Ni, Sn, and stainless steel.

7. The counter electrode of claim 1, wherein the functional interlayer comprises one or more materials selected from the group consisting of nickel, nickel-phosphorous, nickel-tungsten, nickel-cobalt, platinum, palladium, gold, and silver.

8. The counter electrode of claim 1, wherein the functional interlayer comprises a material having a reduction potential above the electrochemical potential range of a metal ion used in reversible metal electrodeposition.

9. The counter electrode of claim 1, wherein the counter electrode comprises a metallic pattern having features less than 200 micrometers in width.

10. The counter electrode of claim 1, wherein the functional interlayer comprises multiple strata of different materials.

11. The counter electrode of claim 10, wherein the multiple strata comprise: a first stratum having intrinsic corrosion-resistance properties; and a second stratum having a reduction potential selected to prevent electrochemical degradation.

12. A method of manufacturing a counter electrode for a reversible metal electrodeposition device, the method comprising:
forming a conductive core;
depositing a functional interlayer on the conductive core; and
forming an active outer shell on the functional interlayer.

13. The method of claim 12, further comprising forming the conductive core on a transparent substrate.

14. The method of claim 12, wherein the functional interlayer comprises at least one material having a reduction potential more positive than a metal ion used in reversible metal electrodeposition.

15. The method of claim 12, wherein depositing the functional interlayer comprises at least one process selected from the group consisting of: physical vapor deposition; chemical vapor deposition; electroplating; electroless plating; and chemical coating.

16. The method of claim 12, wherein forming the conductive core comprises an additive or subtractive manufacturing process.

17. The method of claim 12, further comprising: performing a pre-treatment process on the conductive core prior to depositing the functional interlayer; and performing a post-treatment process after forming the active outer shell.

18. A reversible metal electrodeposition device comprising: a counter electrode of claim 1; and an electrolyte in contact with the counter electrode.

19. The device of claim 18, wherein the functional interlayer prevents leaching of unwanted elements from the conductive core into the electrolyte.

20. The device of claim 18, wherein the device is selected from the group consisting of a glass, a window, a mirror, a panel, a ceiling, an eyewear, a privacy screen, and a display.
